(19) United States
(12) Patent Application Publication
(10) Pub. No.: US 2026/0367645 A1
(43) Pub. Date: Nov. 19, 2026

(54) LANDING SUPPORT

(71) Applicant: The Boeing Company, Arlington, VA (US)

(72) Inventor: Margaret REAGAN, Cambridge, MA (US)

(21) Appl. No.: 19/209,735

(22) Filed: May 15, 2025

(51) Int. Cl. G05D 1/654; B64D 45/04; G05D 109/25

(52) U.S. Cl. CPC G05D 1/654; B64D 45/04; G05D 2109/25

(57) ABSTRACT

In some implementations, a first vehicle may select a landing zone location from among one or more candidate landing zones. The first vehicle may deploy a second vehicle to the landing zone location. The first vehicle may receive, from the second vehicle, a location beacon. The first vehicle may navigate to the landing zone location in accordance with the location beacon.

### FIELD

The present disclosure relates generally to vehicle operation and to navigation of a vehicle to a landing zone.

### BACKGROUND

A vertical takeoff and landing (VTOL) aircraft is a type of vehicle that can perform vertical takeoff, hovering, and landing operations using a propulsion system. When the VTOL aircraft has an electric propulsion system, the VTOL aircraft may be referred to as an electric VTOL (eVTOL) aircraft. The VTOL aircraft may include one or more rotors, propellers, or similar components for generating lift and thrust, which may be powered by one or more motors. An eVTOL aircraft may further include energy storage systems, such as batteries or fuel cells, to provide electrical power to electric motors.

A small unmanned aircraft system (sUAS) includes an unmanned aerial vehicle (UAV) and associated components, such as a ground control station, communication systems, and any other equipment that supports operations of the UAV. The SUAS may be configured for autonomous, semi-autonomous, or remote-controlled operation and may include propulsion systems, navigation systems, sensors, and other components for enabling flight and performing specific tasks.

### SUMMARY

In an aspect, a first vehicle comprises a cargo area for storing a second vehicle; a beacon receiver for receiving a location beacon transmitted from the second vehicle; one or more memories; and one or more processors, coupled to the one or more memories, configured to: select a landing zone location from among one or more candidate landing zones; deploy the second vehicle to the landing zone location; navigate to the landing zone location by following the location beacon transmitted from the second vehicle; and perform a landing operation at the landing zone location.

In a further aspect, the one or more processors, to select the landing zone location, are configured to query a database identifying the one or more candidate landing zones, and wherein the database is stored in the one or more memories.

In a further aspect, the device comprises an avionics system configured to output a present vehicle location; and wherein the database associates each of the one or more candidate landing zones to a geographic location, and wherein the one or more processors, to select the landing zone location, are configured to select the landing zone location in accordance with a proximity of each of the one or more candidate landing zones to the present vehicle location. The database associates each of the one or more candidate landing zones to a geographic location, and wherein the one or more processors, to select the landing zone location, are configured to select the landing zone location in accordance with a proximity of each of the one or more candidate landing zones to the present vehicle location.

In a further aspect, the database associates each of the one or more candidate landing zones to one or more landing characteristics, and wherein the one or more processors, to select the landing zone location, are configured to select the landing zone location in accordance with the one or more landing characteristics of the one or more candidate landing zones.

In a further aspect, at least one of the one or more landing characteristics for each of the one or more candidate landing zones includes an energy expenditure metric, and wherein the one or more processors, to select the landing zone location, are configured to select the landing zone location in accordance with the energy expenditure metric.

In a further aspect, the one or more processors, to deploy the second vehicle to the landing zone location, are configured to: output a landing zone indication to the second vehicle; and release the second vehicle from a cargo area.

In a further aspect, the second vehicle is an unmanned aircraft system.

In an aspect, a method comprises selecting a landing zone location from among one or more candidate landing zones; deploying, from a cargo area of a first vehicle, a second vehicle to the landing zone location; receiving, from the second vehicle, a location beacon; and navigating to the landing zone location by following the location beacon.

In a further aspect, selecting the landing zone location includes querying a database identifying the one or more candidate landing zones.

In a further aspect, the database associates each of the one or more candidate landing zones to a geographic location, and wherein selecting the landing zone location includes selecting the landing zone location in accordance with a proximity of each of the one or more candidate landing zones to a present vehicle location.

In a further aspect, the database associates each of the one or more candidate landing zones to one or more landing characteristics, and wherein selecting the landing zone location includes selecting the landing zone location in accordance with the one or more landing characteristics of the one or more candidate landing zones.

In a further aspect, at least one of the one or more landing characteristics for each of the one or more candidate landing zones includes an energy expenditure metric, and wherein selecting the landing zone location includes selecting the landing zone location in accordance with the energy expenditure metric.

In a further aspect, deploying the unmanned vehicle to the landing zone location includes: outputting a landing zone indication to the unmanned vehicle; and releasing the unmanned vehicle from a cargo area.

In a further aspect, the second vehicle is an unmanned aircraft system.

In an aspect, a non-transitory computer-readable medium storing a set of instructions comprises one or more instructions that, when executed by one or more processors of a first vehicle, cause the vehicle to: select a landing zone location from among one or more candidate landing zones; deploy a second vehicle to the landing zone location; receive, from the second vehicle, a location beacon; navigate to the landing zone location in accordance with the location beacon; and land at the landing zone location.

In an aspect, a vehicle comprises a propulsion system; a docking mechanism; a beacon transmitter configured to transmit a location beacon; one or more memories; and one or more processors, coupled to the one or more memories, configured to: receive a landing zone indication corresponding to a landing zone location; control the propulsion system to navigate to the landing zone location and to land on a landing pad at the landing zone location; activate the docking mechanism to engage a receiving element of the landing pad; and activate the beacon transmitter to transmit a location beacon.

In a further aspect, the one or more processors are further configured to receive the landing zone indication from a VTOL vehicle.

In a further aspect, the one or more processors, to control the propulsion system to navigate to the landing zone location, are configured to control the propulsion system to exit a cargo area of the VTOL vehicle.

In a further aspect, the one or more processors, to activate the docking mechanism to engage the receiver element of the landing pad, are configured to output one or more control signals to an actuator of the docking mechanism.

In a further aspect, the docking mechanism includes one or more magnets, and wherein the one or more processors, to activate the docking mechanism to engage the receiving element of the landing pad, are configured to control the propulsion system to align the one or more magnets of the docking mechanism with the receiving element of the landing pad.

In a further aspect, the one or more processors, to navigate to the landing zone location, are configured to control the propulsion system to navigate to the landing zone location in accordance with a satellite positioning operation.

In an aspect, a method comprises receiving a landing zone indication corresponding to a landing zone location; navigating to the landing zone location; landing on a landing pad at the landing zone location; engaging a receiving element of the landing pad; and activating a beacon transmitter.

In a further aspect, receiving the landing zone indication includes receiving the landing zone indication from a VTOL vehicle.

In a further aspect, navigating to the landing zone location includes exiting a cargo area of the VTOL vehicle.

In a further aspect, engaging the receiver element of the landing pad includes activating a docking mechanism.

In a further aspect, activating the docking mechanism includes outputting a control signal to an actuator.

In a further aspect, engaging the receiving element of the landing pad includes aligning one or more magnets with the receiving element.

In a further aspect, activating the beacon transmitter includes activating an infrared transmitter.

In a further aspect, navigating to the landing zone location includes navigating to the landing zone location via a satellite positioning operation.

In an aspect, a non-transitory computer-readable medium storing a set of instructions comprises one or more instructions that, when executed by one or more Harrity processors of an unmanned vehicle, cause the unmanned vehicle to: receive a landing zone indication corresponding to a landing zone location; navigate to the landing zone location; land on a landing pad at the landing zone location; engage a receiving element of the landing pad; and activate a beacon transmitter.

The features, functions, and advantages that have been discussed can be achieved independently in various implementations or may be combined in yet other implementations further details of which can be seen with reference to the following description and drawings.

### BRIEF DESCRIPTION OF THE DRAWINGS

FIG. 1 is a diagram of an example implementation associated with landing support for a first vehicle.

FIGS. 2-3 are diagrams of example implementations associated with a docking mechanism for anchoring a second vehicle to a receiving element of a landing pad.

FIG. 4 is a diagram of an example implementation associated with stowing the second vehicle in a cargo area of the first vehicle.

FIGS. 5-6 are diagrams of example components of devices associated with autonomous flight operations.

FIGS. 7-8 are flowcharts of example processes associated with landing support.

### DETAILED DESCRIPTION

The following detailed description of example implementations refers to the accompanying drawings. The same reference numbers in different drawings may identify the same or similar elements.

An autonomous (e.g., fully autonomous or semi-autonomous) eVTOL vehicle may be configured to perform flight operations (e.g., takeoff operations, in-flight operations, and/or landing operations) with varying degrees of human interaction. For example, a fully autonomous eVTOL vehicle may be capable of takeoff operations, in-flight operations, and/or landing operations with no human interaction while a semi-autonomous eVTOL vehicle may be capable of performing at least a portion of one or more flight operations without human interaction.

An autonomous eVTOL vehicle may rely on multiple systems when autonomously performing flight operations. For example, for a landing operation, the eVTOL vehicle may use a navigation system to locate a landing zone and a propulsion system to direct the eVTOL vehicle onto a landing pad at the landing zone. A system failure may compromise the eVTOL vehicle's ability to autonomously perform one or more flight operations. For example, if the navigation system of the eVTOL fails or if a satellite positioning system is temporarily inoperable, the eVTOL vehicle may be unable to autonomously locate the landing zone. Accordingly, the eVTOL vehicle may employ redundancy to allow at least some flight operations to succeed despite one or more failed systems used by the eVTOL vehicle.

Some implementations described herein enable an autonomous eVTOL vehicle to perform one or more flight operations. Some implementations described herein enable the eVTOL vehicle to locate and navigate to a landing zone without the eVTOL vehicle relying on a satellite positioning system. For example, in some implementations, the eVTOL vehicle may deploy an sUAS to the landing zone. The SUAS may transmit a beacon that the eVTOL vehicle can follow to the landing zone. As a result, the eVTOL vehicle can perform at least some autonomous flight operations (e.g., autonomously landing at the landing zone), even after the eVTOL has lost communication with the satellite positioning system.

Some implementations described herein enable the sUAS to secure itself to a landing pad at the landing zone. For example, while the eVTOL vehicle is landing at the landing pad, the eVTOL vehicle may create significant air turbulence. If the turbulence were to push the sUAS off the landing pad, the eVTOL may follow the sUAS and land away from the landing pad. Accordingly, by securing the sUAS to the landing pad, the sUAS will stay in place during the autonomous landing flight operation performed by the eVTOL vehicle. In some aspects, because the eVTOL vehicle and the sUAS may operate autonomously, the SUAS may secure itself to the landing pad without human interaction, thereby allowing the SUAS and the eVTOL vehicle to land at landing zones without requiring that one or more people be present during the autonomous landing flight operation.

Although described in the context of an eVTOL vehicle and an sUAS, the concepts disclosed herein may be applicable to other types of vehicles, including manned vehicles, unmanned vehicles, electric vehicles (e.g., vehicles with an electrically powered propulsion system), non-electric vehicles (e.g., vehicles with a non-electrically powered propulsion system), autonomous or partially autonomous vehicles, non-autonomous vehicles, or a combination thereof, among other examples. As used herein, “unmanned” may refer to a vehicle that does not have a human pilot. In some aspects, an unmanned vehicle is an autonomous vehicle. Alternatively or in addition, an unmanned vehicle may refer to a vehicle that is remotely piloted by a human. In some aspects, an unmanned vehicle may carry human passengers.

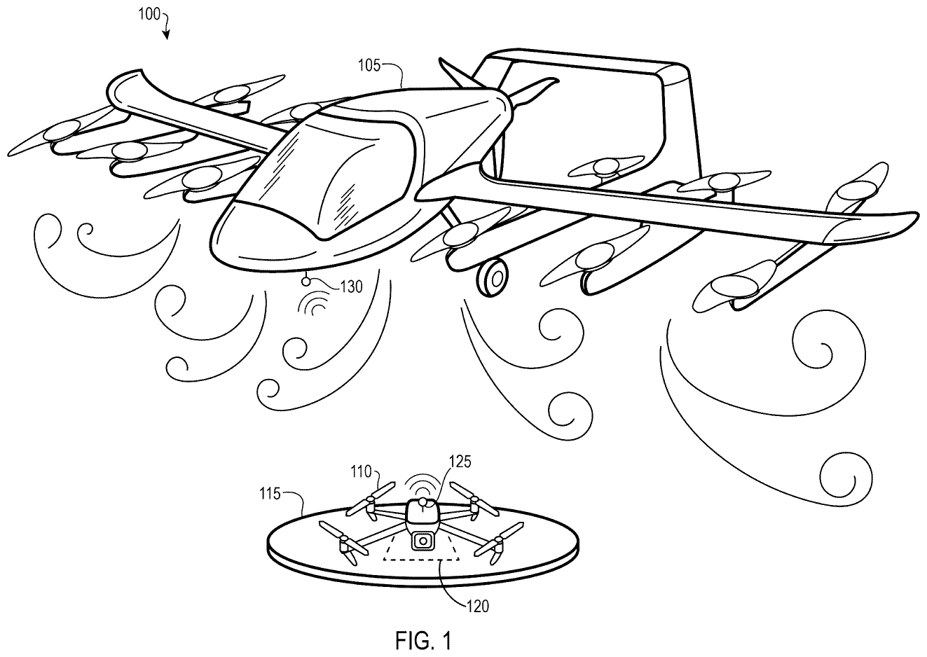

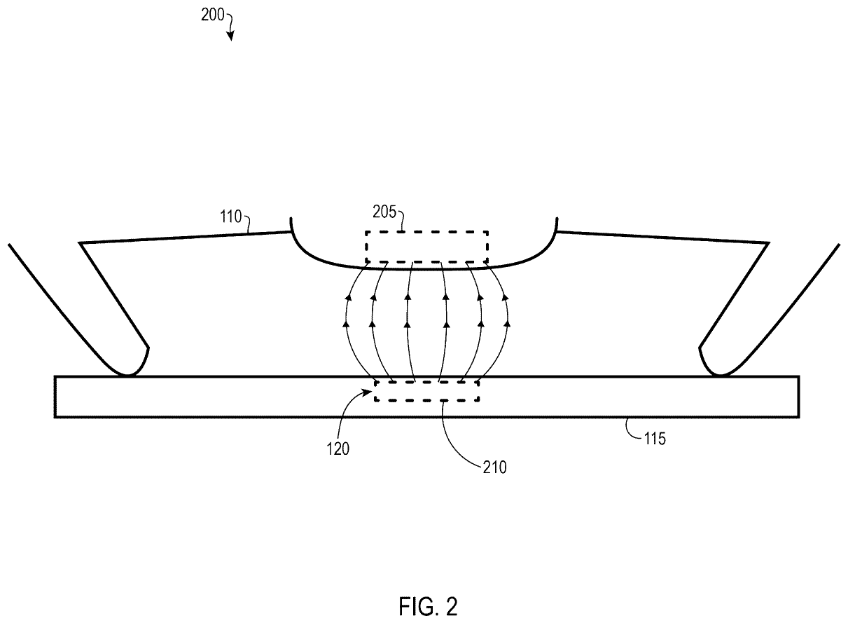

FIG. 1 is a diagram of an example implementation 100 associated with landing support for a first vehicle, such as an eVTOL vehicle. As shown in FIG. 1, example implementation 100 includes an eVTOL vehicle 105, a second vehicle (e.g., an sUAS 110), and a landing pad 115. These devices are described in more detail below and in connection with FIGS. 2-6.

The eVTOL vehicle 105 may be configured to perform one or more autonomous flight operations. Examples of flight operations may include takeoff operations, in-flight operations (which may include hovering), and/or landing operations. In some aspects, the eVTOL vehicle 105 may be configured to perform vertical takeoff operations and/or vertical landing operations. During vertical takeoff operations and vertical landing operations, a primary direction of movement of the eVTOL vehicle 105 may be perpendicular to a ground surface. Accordingly, vertical takeoff operations and vertical landing operations may allow the eVTOL vehicle 105 to depart and land, respectively, without a runway.

In some aspects, the eVTOL vehicle 105 may be configured to select a landing zone location from among one or more candidate landing zones, deploy an unmanned vehicle (e.g., the sUAS 110) to the landing zone location, navigate to the landing zone location in accordance with a location beacon transmitted from the unmanned vehicle, and perform a landing operation at the landing zone location. For example, the eVTOL vehicle 105 may be configured to query a database that identifies the one or more candidate landing zones and select the landing zone location as a result of querying the database. The eVTOL vehicle 105 may be configured to query the database and/or select the landing zone location according to a distance of the candidate landing zones to the eVTOL vehicle 105, one or more landing characteristics associated with the candidate landing zones, an energy expenditure metric associated with each of the candidate landing zones, and/or a combination thereof, among other examples. The one or more landing characteristics may be a value, parameter, or other representation of a difficulty associated with landing at the candidate landing zone. For example, landing the eVTOL vehicle 105 at a candidate landing zone surrounded by trees, uneven terrain, water, a population center, roads or other infrastructure (e.g., power lines, bridges, fences, among other examples), or air traffic near the candidate landing zone may be more difficult than landing the eVTOL vehicle 105 at a candidate landing zone in an empty field. The energy expenditure metric may be a value, parameter, or other representation of an amount of energy the eVTOL vehicle 105 may expend to land at the candidate landing zone. The energy expenditure metric may be associated with the distance between the candidate landing zone and the eVTOL vehicle 105, the landing characteristics, an amount of time for the eVTOL vehicle 105 to arrive at the candidate landing zone, and/or a combination thereof, among other examples. Additionally or alternatively, the energy expenditure metric may be associated with an amount of energy the sUAS 110 may expend to navigate to the candidate landing zone and transmit a location beacon until the eVTOL vehicle 105 has landed at the candidate landing zone.

The eVTOL vehicle 105 may communicate the selected landing zone location to the SUAS 110 via a landing zone indication prior to deploying the sUAS 110. For example, the SUAS 110 may be stowed in the eVTOL vehicle 105 prior to deploying the sUAS 110 to the selected landing zone location. The eVTOL vehicle 105 may communicate with the SUAS 110 while the sUAS 110 is stowed via a wired or wireless communication network.

Accordingly, the eVTOL vehicle 105 may transmit the landing zone indication to the SUAS 110 while the sUAS 110 is stowed in the eVTOL vehicle 105. As discussed in greater detail below, after selecting the landing zone location, the eVTOL vehicle 105 may deploy the SUAS 110 from a cargo area of the eVTOL vehicle 105, and the eVTOL vehicle 105 may follow a location beacon, transmitted by the sUAS 110, to the selected landing zone location.

The SUAS 110 is an unmanned vehicle (e.g., an unmanned aerial vehicle (UAV)) that may be configured to perform one or more autonomous flight operations. For example, the sUAS 110 may be configured to receive the landing zone indication corresponding to the landing zone location selected by the eVTOL vehicle 105. The SUAS 110 may be configured to receive the landing zone indication via a wired or wireless communication network. In some aspects, the sUAS 110 may be deployed from the eVTOL vehicle 105 before receiving the landing zone indication via a wireless communication. Alternatively, the sUAS 110 may receive the landing zone indication, via a wired or wireless communication, before being deployed from the eVTOL vehicle 105.

The SUAS 110 may be configured to autonomously navigate to the landing zone location and land on the landing pad 115 located at the landing zone location. The SUAS 110 may be configured to transmit the location beacon after being deployed from the eVTOL vehicle 105. For example, the sUAS 110 may be configured to transmit the location beacon while in flight to the landing zone location and continue to transmit the location beacon after landing at the landing zone location. Alternatively or additionally, the sUAS 110 may be configured to begin transmitting the location beacon after landing at the landing zone location.

In some aspects, the eVTOL vehicle 105 may create a downdraft when landing on the landing pad. The downdraft may be significant enough to push the sUAS 110 off the landing pad 115. Pushing the sUAS 110 off the landing pad 115 may damage the SUAS 110, the landing pad 115, or both. Further, pushing the sUAS 110 off the landing pad 115 may cause the eVTOL vehicle 105 to miss the landing pad 115. Depending on the environment surrounding the landing pad 115, missing the landing pad 115 may cause damage to the eVTOL vehicle 105. Accordingly, the sUAS 110 may anchor itself to the landing pad 115 before the downdraft created by the eVTOL vehicle 105 is significant enough to push the SUAS 110 off the landing pad 115. In some aspects, and as discussed in greater detail below, the sUAS 110 may anchor itself to a receiving element 120 of the landing pad 115.

The SUAS 110 may be configured to transmit the location beacon via a beacon transmitter 125. In some aspects, the beacon transmitter 125 may be an infrared transmitter. The eVTOL vehicle 105 may include a beacon receiver 130 configured to detect the location beacon transmitted by the beacon transmitter 125 of the sUAS 110. In some aspects, the beacon receiver 130 of the eVTOL vehicle 105 may include an infrared receiver.

Using a beacon receiver 130 can provide more accuracy than using a Global Navigation Satellite System (GNSS), such as a Global Positioning System (GPS), to land the eVTOL vehicle 105. For example, infrared-based positioning systems have higher spatial resolution and lower latency than GNSS-based positioning systems. For example, with an infrared-based positioning system, the eVTOL vehicle 105 can follow the beacon transmitted by the beacon transmitter 125 of the sUAS 110 and land on the landing pad 115 within a meter of the sUAS 110. GNSS-based positioning systems do not allow for that level of precision. Accordingly, if relying on a GNSS-based positioning system, the eVTOL 105 is limited to landing zone locations with large clearances. Additionally, compared to GNSS-based positioning systems, infrared-based positioning systems are more resilient to signal degradation caused by atmospheric distortion or multipath effects, which may further improve accuracy when the eVTOL 105 navigates to and lands at the landing zone by following the beacon.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1.

Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

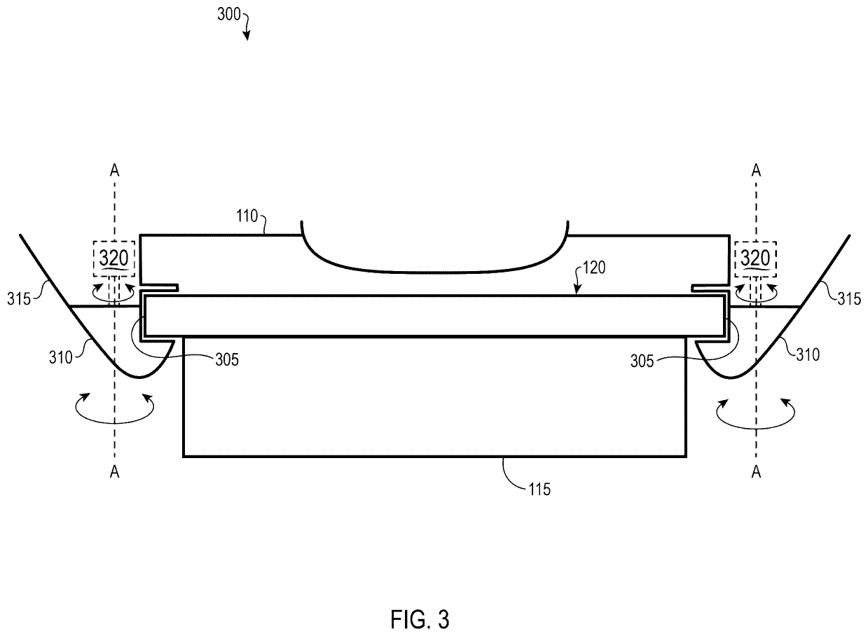

FIGS. 2-3 are diagrams of example implementations 200 and 300, respectively, associated with a docking mechanism for anchoring the sUAS 110 to the receiving element 120 of the landing pad 115. By anchoring the sUAS 110 to the landing pad 115, the sUAS 110 is more likely to remain in place while another vehicle (e.g., the eVTOL vehicle 105 of FIG. 1) is landing on the landing pad 115 overtop of the sUAS 110. For example, anchoring the sUAS 110 to the landing pad 115 reduces the likelihood that a downdraft caused by the other vehicle approaching the landing pad 115 will push the sUAS 110 off the landing pad 115. Keeping the sUAS 110 stationary while the other vehicle is landing on the landing pad 115 further increases the likelihood that the other vehicle will land on the landing pad 115, thereby increasing precision of the landing.

With reference to the example implementation 200 of FIG. 2, the docking mechanism of the sUAS 110 may include at least one docking magnet 205. The docking magnet 205 may be configured to magnetically engage at least one receiving magnet 210 of the receiving element 120. The docking magnet 205 and the receiving magnet 210 may each generate a magnetic field. The magnetic field may cause the docking magnet 205 and the receiving magnet 210 to magnetically attract one another. In some aspects, the docking magnet 205, the receiving magnet 210, or both, may be electromagnets, and the magnetic fields of the docking magnet 205 and/or the receiving magnet 210 may be generated in accordance with an electric current. In some aspects, a strength of the magnetic field between the docking magnet 205 and the receiving magnet 210 may be strong enough to keep the SUAS 110 on the landing pad 115 despite the downdraft created by the eVTOL aircraft during a landing operation or a takeoff operation. In some aspects, the sUAS 110 may include multiple docking magnets. In some aspects, the receiving element 120 may include multiple receiving magnets.

With reference to the example implementation 300 of FIG. 3, the docking mechanism of the sUAS 110 may be configured to engage a lip 305 of the receiving element 120 of the landing pad 115. For example, the docking mechanism may include feet 310 located on each of two or more legs 315 of the SUAS 110. The feet 310 may be configured to snap into or otherwise engage the lip 305 of the receiving element 120. For example, the feet 310 may be rotatable about an axis A, and motors 320 may be operably attached to the feet and configured to rotate the feet 310 to a locked position to engage the lip 305 of the receiving element 120. The motors 320 may be further configured to rotate the feet 310 to an unlocked position. When in in the unlocked position, the feet 310 may allow the sUAS 110 to disengage from the lip 305 of the receiving element 120. When the feet 310 are in the unlocked position, the sUAS 110 may be able to perform a takeoff operation from the landing pad 115.

In some aspects, the docking mechanism may include multiple features to help keep the sUAS 110 in place while the eVTOL aircraft is performing a flight operation on or near the landing pad 115. For example, the docking mechanism of the sUAS 110 may include the docking magnet 205 and the feet 310. For example, the docking magnet 205 may engage the receiving magnet 210 of the landing pad 115 while the feet 310 engage the lip 305 of the landing pad 115.

As indicated above, FIGS. 2-3 are provided as examples. Other examples may differ from what is described with regard to FIGS. 2-3. The number and arrangement of devices shown in FIGS. 2-3 are provided as examples. In practice, there may be additional devices, fewer devices, different devices, or differently arranged devices than those shown in FIGS. 2-3. Furthermore, two or more devices shown in FIGS. 2-3 may be implemented within a single device, or a single device shown in FIGS. 2-3 may be implemented as multiple, distributed devices. Additionally, or alternatively, a set of devices (e.g., one or more devices) shown in FIGS. 2-3 may perform one or more functions described as being performed by another set of devices shown in FIGS. 2-3.

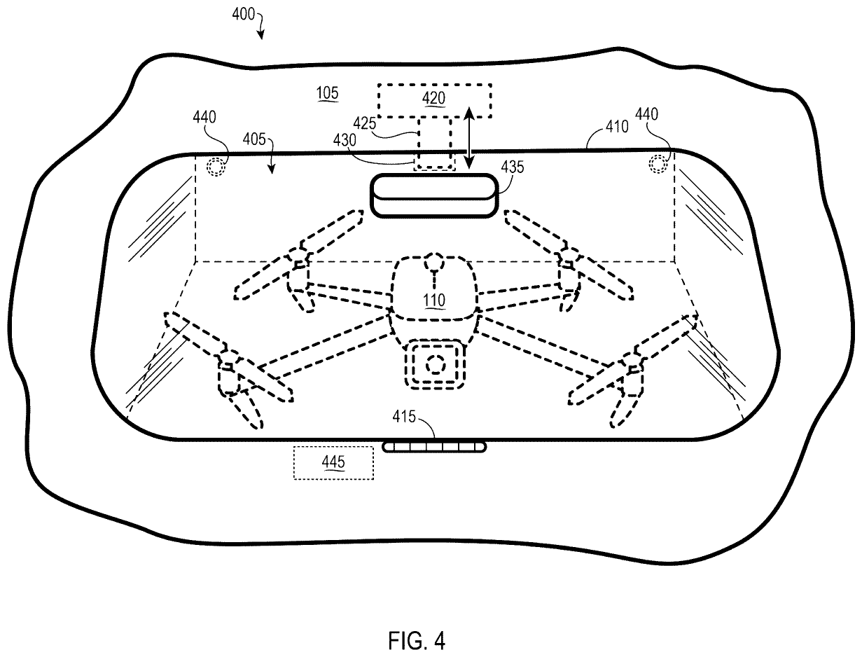

FIG. 4 is a diagram of an example implementation 400 associated with stowing the SUAS 110 in a cargo area 405 of the eVTOL vehicle 105. In some aspects, the cargo area 405 may be an open space in a body of the eVTOL vehicle 105. The cargo area 405 may be accessible through a door 410. The door 410 may be configured to open by rotating about one or more hinges 415 that connect the door 410 to the body of the eVTOL vehicle 105.

When the door 410 is open, the sUAS 110 may be able to exit the cargo area 405 of the eVTOL vehicle 105.

The door 410 may be configured to lock, unlock, and open automatically (e.g., without human intervention) via a door actuator 420 and a latch 425. For example, to lock the door 410, the door actuator 420 may be configured to extend the latch 425 from the body of the eVTOL vehicle 105 into a corresponding slot 430 in the door 410. To unlock the door 410, the door actuator 420 may be configured to withdraw the latch 425 from the corresponding slot 430 in the door 410. In some aspects, the door 410 may be unlocked and/or opened manually via a handle 435. In some aspects, the door 410 may be biased toward an open position. For example, in some aspects, gravity may cause the door 410 to open when the door 410 is unlocked. Alternatively or additionally, one or more springs 440 may be configured to push the door 410 open when the door 410 is unlocked. In some aspects, the eVTOL vehicle 105 may include one or more actuators 445 configured to close the door 410 after the SUAS 110 has exited the cargo area 405.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4.

Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

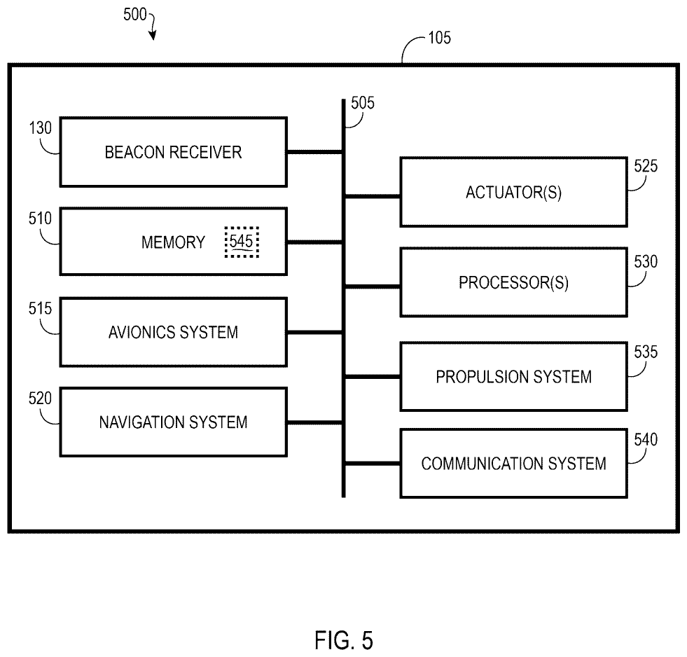

FIG. 5 is a diagram of example components of a device 500 associated with autonomous flight operations. The device 500 may correspond to one or more components of the eVTOL vehicle 105. In some implementations, the eVTOL vehicle 105 may include one or more devices 500 and/or one or more components of the device 500. As shown in FIG. 5, the device 500 may include a bus 505, the beacon receiver 130, a memory 510, an avionics system 515, a navigation system 520, one or more actuators 525, one or more processors 530, a propulsion system 535, and/or a communication system 540.

The bus 505 may include one or more components that enable wired and/or wireless communication among the components of the device 500. The bus 505 may couple together two or more components of FIG. 5, such as via operative coupling, communicative coupling, electronic coupling, and/or electric coupling. For example, the bus 505 may include an electrical connection (e.g., a wire, a trace, and/or a lead) and/or a wireless bus.

The beacon receiver 130 may include an infrared receiver configured to receive a location beacon transmitted from, for example, a beacon transmitter (e.g., the beacon transmitter 125 of the sUAS 110 shown in FIG. 1). In some aspects, the beacon receiver 130 may be configured to output, on the bus 505, one or more signals indicating that the location beacon has been detected. In some aspects, the beacon receiver 130 may be configured to output, on the bus 505, one or more signals indicating a direction of the beacon transmitter.

The memory 510 may include volatile and/or nonvolatile memory. For example, the memory 510 may include random access memory (RAM), read only memory (ROM), a hard disk drive, and/or another type of memory (e.g., a flash memory, a magnetic memory, and/or an optical memory). The memory 510 may include internal memory (e.g., RAM, ROM, or a hard disk drive) and/or removable memory (e.g., removable via a universal serial bus connection). The memory 510 may be a non-transitory computer-readable medium. The memory 510 may store information, one or more instructions, and/or software (e.g., one or more software applications) related to the operation of the device 500. In some implementations, the memory 510 may include one or more memories that are coupled (e.g., communicatively coupled) to one or more processors (e.g., processor 530), such as via the bus 505. Communicative coupling between a processor 530 and a memory 510 may enable the processor 530 to read and/or process information stored in the memory 510 and/or to store information in the memory 510.

In some aspects, the memory 510 may store a database 545. The database 545 may associate each candidate landing zone, discussed above, with additional information such as the geographic location of the candidate landing zone, the landing characteristics associated with each candidate landing zone, and/or the energy expenditure metrics associated with each candidate landing zone.

The avionics system 515 may include one or more electronic components configured to collect, transmit, and/or process data related to the operation, status, and/or environment of a vehicle. The avionics system 515 be configured to interface with components of the eVTOL vehicle 105, via the bus 505, to monitor parameters such as speed, location, performance, energy levels, and diagnostic information associated with the flight operations performed by the eVTOL vehicle 105. For example, the avionics system 515 may be configured to determine a present vehicle location, battery charge, battery range, and/or a combination thereof, among other examples, of the eVTOL vehicle 105.

The navigation system 520 may include one or more electronic components configured to determine a position, direction, and route of the eVTOL vehicle 105. In some aspects, the navigation system 520 may be configured to determine the position, direction, and route of the eVTOL vehicle 105 via communication with a satellite-based positioning system such as a GNSS. In some aspects, the navigation system 520 may be configured to output data corresponding to the position, direction, and/or route of the eVTOL vehicle 105 to other components of the device 500 via the bus 505.

The actuators 525 may include one or more electronic components configured to move in accordance with a control signal. In some aspects, the actuators 525 may be configured to operate in accordance with one or more control signals received via the bus 505. Each of the actuators 525 may be or include an electric motor, a linear actuator, a solenoid, and/or a combination thereof, among other examples. Accordingly, examples of the actuators 525 may include the actuators 420 and/or 445 of FIG. 4, among other examples.

The processor 530 may include a central processing unit, a graphics processing unit, a microprocessor, a controller, a microcontroller, a digital signal processor, a field-programmable gate array, an application-specific integrated circuit, and/or another type of processing component. The processor 530 may be implemented in hardware, firmware, or a combination of hardware and software. In some implementations, the processor 530 may include one or more processors capable of being programmed to perform one or more operations or processes described elsewhere herein.

For example, in some aspects, the processor 530 may be configured to select the landing zone location from among the one or more candidate landing zones, deploy the sUAS (e.g., the sUAS 110 of FIG. 1) to the landing zone location, navigate to the landing zone location in accordance with the location beacon, and perform a landing operation at the landing zone location. To select the landing zone location, the processor 530 may be configured to query the database 545 stored in the memory 510. In some aspects, the processor 530 may be further configured to select the landing zone location in accordance with a proximity of the eVTOL vehicle 105 to each of the candidate landing zones in accordance with the present vehicle location output by the avionics system 515. In some aspects, the processor 530 may be configured to select the landing zone location in accordance with the landing characteristics, the energy expenditure metric, and/or a combination thereof, among other examples. Accordingly, the processor 530 may be configured to select the landing zone location based on, for example, the battery charge and/or the battery range of the eVTOL vehicle 105, among other examples. In some aspects, the processor 530 may be configured to release the sUAS from the cargo area (e.g., the cargo area 405) of the eVTOL vehicle 105. For example, the processor 530 may be configure to output, via the bus 505, a control signal to a door actuator (e.g., the door actuator) 420 of FIG. 4 to release a latch (e.g., the latch 425 of FIG. 4) from a corresponding slot (e.g., the corresponding slot 430) in the body of the eVTOL vehicle 105.

The propulsion system 535 may include one or more components configured to propel the eVTOL vehicle 105. For example, the propulsion system 535 may include one or more motors, each configured to rotate a propeller. The propulsion system 535 may include one or more motor controllers configured to receive control signals via the bus 505. The motor controllers may be configured to receive the control signals and output, to the motors, control signals that cause the motors to rotate the propellers in accordance with the one or more flight operations. For example, rotating the propellers may cause the eVTOL vehicle 105 to perform a takeoff operation, an inflight operation, or a landing operation. In some aspects, the propulsion system 535 may be configured control the propulsion of the eVTOL vehicle 105 toward a target destination, such as the landing zone location. In some aspects, the propulsion system 535 may be configured to control the propulsion of the eVTOL vehicle 105 such that the eVTOL vehicle 105 lands on the landing pad located at the landing zone location.

The communication system 540 may include one or more electronic components configured for wired or wireless communication. For example, the communication system may include one or more receivers, transmitters, modems, network interface cards, antennas, chips, circuits, or other components that facilitate wired and/or wireless communication with the SUAS. The communication system 540 may be configured to receive the landing zone indication via the bus 505 and output the landing zone indication to the sUAS. In some aspects, the communication system 540 may output the landing zone indication to the SUAS prior to the sUAS being deployed from the eVTOL vehicle 105. For example, the communication system 540 may output the landing zone indication to the sUAS prior to the SUAS being released from the cargo area of the eVTOL vehicle 105. Additionally, in some aspects, the communication system 540 may output an arrival indication to the SUAS indicating that the eVTOL vehicle 105 has arrived at the landing zone and/or landed on the landing pad.

The device 500 may perform one or more operations or processes described herein. For example, a non-transitory computer-readable medium (e.g., memory 510) may store a set of instructions (e.g., one or more instructions or code) for execution by the processor 530.

The processor 530 may execute the set of instructions to perform one or more operations or processes described herein. In some implementations, execution of the set of instructions, by one or more processors 530, causes the one or more processors 530 and/or the device 500 to perform one or more operations or processes described herein. In some implementations, hardwired circuitry may be used instead of or in combination with the instructions to perform one or more operations or processes described herein. Additionally, or alternatively, the processor 530 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

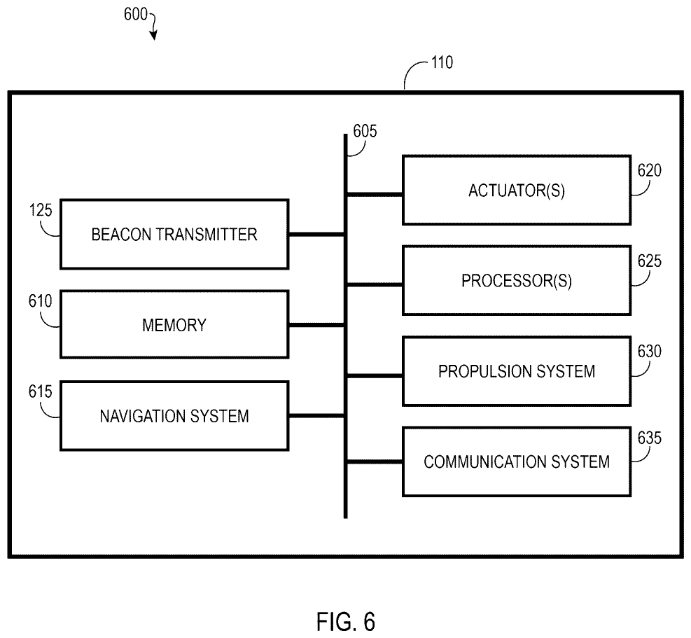

FIG. 6 is a diagram of example components of a device 600 associated with autonomous flight operations. The device 600 may correspond to one or more components of the SUAS 110. In some implementations, the sUAS 110 may include one or more devices 600 and/or one or more components of the device 600. As shown in FIG. 6, the device 600 may include a bus 605, the beacon transmitter 125, a memory 610, a navigation system 615, one or more actuators 620, one or more processors 625, a propulsion system 630, and/or a communication system 635.

The bus 605 may include one or more components that enable wired and/or wireless communication among the components of the device 600. The bus 605 may couple together two or more components of FIG. 6, such as via operative coupling, communicative coupling, electronic coupling, and/or electric coupling. For example, the bus 605 may include an electrical connection (e.g., a wire, a trace, and/or a lead) and/or a wireless bus.

The beacon transmitter 125 may include an infrared transmitter configured to transmit a location beacon. The beacon transmitter 125 may be configured to transmit the location beacon in accordance with one or more control signals. In some aspects, the beacon transmitter 125 may receive the one or more control signals via the bus 605, and the beacon transmitter 125 may activate upon receiving the one or more control signals. In some aspects, the beacon transmitter 125 may continue transmitting the location beacon until a control signal deactivating the beacon transmitter 125 is received via the bus 605. For example, the beacon transmitter 125 may continue transmitting the location beacon until the eVTOL aircraft (e.g., the eVTOL vehicle 105 of FIG. 1) outputs a communication, to the SUAS 110, indicating that the eVTOL vehicle 105 has arrived at the landing zone and/or landed on the landing pad.

The memory 610 may include volatile and/or nonvolatile memory. For example, the memory 610 may include RAM, ROM, a hard disk drive, and/or another type of memory (e.g., a flash memory, a magnetic memory, and/or an optical memory). The memory 610 may include internal memory (e.g., RAM, ROM, or a hard disk drive) and/or removable memory (e.g., removable via a universal serial bus connection). The memory 610 may be a non-transitory computer-readable medium. The memory 610 may store information, one or more instructions, and/or software (e.g., one or more software applications) related to the operation of the device 600. In some implementations, the memory 610 may include one or more memories that are coupled (e.g., communicatively coupled) to one or more processors (e.g., processor 625), such as via the bus 605. Communicative coupling between a processor 625 and a memory 610 may enable the processor 625 to read and/or process information stored in the memory 610 and/or to store information in the memory 610.

The navigation system 615 may include one or more electronic components configured to determine a position, direction, and route of the sUAS 110. In some aspects, the navigation system 615 may be configured to determine the position, direction, and route of the SUAS 110 via communication with a satellite-based positioning system such as GNSS. In some aspects, the navigation system 615 may be configured to output data corresponding to the position, direction, and/or route of the sUAS 110 to other components of the device 600 via the bus 605.

The actuators 620 may include one or more electronic components configured to move in accordance with a control signal. In some aspects, the actuators 620 may be configured to operate in accordance with one or more control signals received via the bus 605. Each of the actuators 620 may be or include an electric motor, a linear actuator, a solenoid, and/or a combination thereof, among other examples. Accordingly, an example of the actuators 620 may include the motors 320 of FIG. 3, among other examples.

The processor 625 may include a central processing unit, a graphics processing unit, a microprocessor, a controller, a microcontroller, a digital signal processor, a field-programmable gate array, an application-specific integrated circuit, and/or another type of processing component. The processor 625 may be implemented in hardware, firmware, or a combination of hardware and software. In some implementations, the processor 625 may include one or more processors capable of being programmed to perform one or more operations or processes described elsewhere herein.

For example, in some aspects, the processor 625 may be configured to receive the landing zone indication from the eVTOL aircraft, control the propulsion system 630 to navigate to the landing zone location and to land on a landing pad at the landing zone location. The processor 625 may be further configured to activate the docking mechanism (e.g., via an electromagnet (e.g., magnet 205) of FIG. 2 and/or the feet 310 of FIG. 3) to engage a receiving element (e.g., the receiving element 120 of FIG. 1) of the landing pad. In some aspects, the processor 625 may be configured to output one or more control signals, via the bus 605, to activate the beacon transmitter 125 to transmit the location beacon.

The processor 625 may be configured to receive the landing zone indication from the eVTOL aircraft and output one or more control signals, along the bus 605, to facilitate navigation of the sUAS 110 to the landing zone location. For example, the processor 625 may be configured to provide the landing zone location to the navigation system 615 and/or the propulsion system 630 via the bus 605. In some aspects, the processor 625 may be configured to output one or more control signals to, for example, the propulsion system 630 to cause the sUAS 110 to exit the cargo area of the eVTOL aircraft. In some aspects, the processor 625 may be configured to output one or more control signals, via the bus 605, to activate the docking mechanism. For example, the processor 625 may be configured to output one or more control signals to the actuators 620 to activate the docking mechanism to engage the receiver element of the landing pad. In some aspects, the processor 625 may be configured to output one or more control signals via the bus 605 to align the magnet of the docking mechanism with the receiving element of the landing pad. For example, the processor 625 may be configured to output one or more control signals to the propulsion system 630 that cause the propulsion system 630 to navigate the sUAS 110 to a location, relative to the landing pad, where the magnet (e.g., magnet 205) of the sUAS 110 is aligned with a corresponding magnet (e.g., magnet 210) of the receiving element.

The propulsion system 630 may include one or more components configured to propel the sUAS 110. For example, the propulsion system 630 may include one or more motors, each configured to rotate a propeller. The propulsion system 630 may include one or more motor controllers configured to receive control signals via the bus 605. The motor controllers may be configured to receive the control signals and output, to the motors, control signals that cause the motors to rotate the propellers in accordance with the one or more flight operations. For example, rotating the propellers may cause the sUAS 110 to perform a takeoff operation, an inflight operation, or a landing operation. In some aspects, the propulsion system 630 may be configured control the propulsion of the sUAS 110 toward a target destination, such as the landing zone location. In some aspects, the propulsion system 630 may be configured to control the propulsion of the sUAS 110 such that the SUAS 110 lands on the landing pad located at the landing zone location.

The communication system 635 may include one or more electronic components configured for wired or wireless communication. For example, the communication system may include one or more receivers, transmitters, modems, network interface cards, antennas, chips, circuits, or other components that facilitate wired and/or wireless communication with the eVTOL aircraft. The communication system 635 may be configured to receive the landing zone indication from the eVTOL aircraft and output the landing zone indication to one or more components of the device 600 via the bus 605. In some aspects, the communication system 635 may receive the landing zone indication from the eVTOL aircraft prior to the sUAS 110 being deployed from the eVTOL aircraft. For example, the communication system 635 may receive the landing zone indication prior to the sUAS 110 being released from the cargo area of the eVTOL aircraft. In some aspects, the communication system 635 may receive the arrival indication after the eVTOL aircraft has arrived at the landing zone location and/or landed on the landing pad. In some aspects, the communication system 635 may output the arrival indication via the bus 605, and the beacon transmitter 125 may discontinue transmitting the location beacon after the communication system 635 receives the arrival indication.

The device 600 may perform one or more operations or processes described herein. For example, a non-transitory computer-readable medium (e.g., memory 610) may store a set of instructions (e.g., one or more instructions or code) for execution by the processor 625.

The processor 625 may execute the set of instructions to perform one or more operations or processes described herein. In some implementations, execution of the set of instructions, by one or more processors 625, causes the one or more processors 625 and/or the device 600 to perform one or more operations or processes described herein. In some implementations, hardwired circuitry may be used instead of or in combination with the instructions to perform one or more operations or processes described herein. Additionally, or alternatively, the processor 625 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

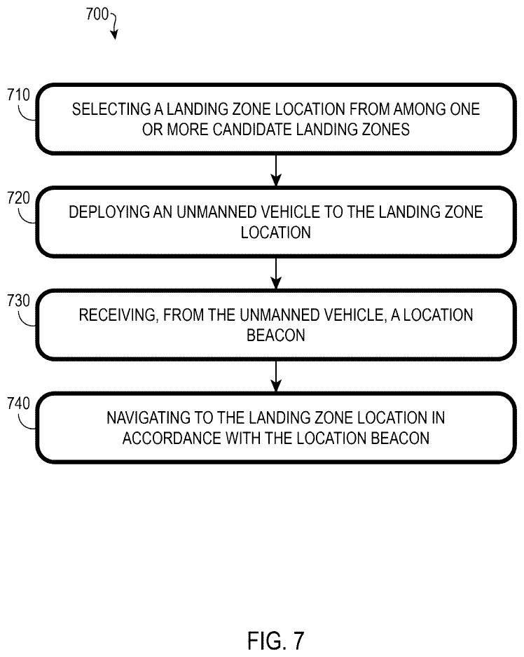

FIG. 7 is a flowchart of an example process 700 associated with landing support.

One or more process blocks of FIG. 7 are performed by a first vehicle (e.g., eVTOL vehicle 105) and/or by another device or a group of devices separate from or including the first vehicle. Additionally, or alternatively, one or more process blocks of FIG. 7 may be performed by one or more components of device 500, such as a beacon receiver 130, memory 510, avionics system 515, navigation system 520, actuators 525, processor 530, propulsion system 535, and/or communication system 540.

As shown in FIG. 7, process 700 includes selecting a landing zone location from among one or more candidate landing zones (block 710). For example, the first vehicle may select a landing zone location from among one or more candidate landing zones, as described above.

As further shown in FIG. 7, process 700 includes deploying a second vehicle to the landing zone location (block 720). For example, the first vehicle may deploy a second vehicle (e.g., the sUAS 110 of FIG. 1) to the landing zone location, as described above.

As further shown in FIG. 7, process 700 includes receiving, from the unmanned vehicle, a location beacon (block 730). For example, the first vehicle may receive, from the second vehicle, an infrared location beacon, as described above.

As further shown in FIG. 7, process 700 includes navigating the first vehicle to the landing zone location by following the infrared location beacon transmitted by the second vehicle (block 740). For example, the first vehicle may navigate to the landing zone location by following the infrared location beacon transmitted by the second vehicle, as described above.

Process 700 may include additional aspects, such as any single aspect or any combination of aspects described below and/or in connection with one or more other processes described elsewhere herein.

In a first aspect, selecting the landing zone location includes querying a database identifying the one or more candidate landing zones.

In a second aspect, alone or in combination with the first aspect, the database associates each of the one or more candidate landing zones to a geographic location, and wherein selecting the landing zone location includes selecting the landing zone location in accordance with a proximity of each of the one or more candidate landing zones to a present vehicle location.

In a third aspect, alone or in combination with one or more of the first and second aspects, the database associates each of the one or more candidate landing zones to one or more landing characteristics, and wherein selecting the landing zone location includes selecting the landing zone location in accordance with the one or more landing characteristics of the one or more candidate landing zones.

In a fourth aspect, alone or in combination with one or more of the first through third aspects, at least one of the one or more landing characteristics for each of the one or more candidate landing zones includes an energy expenditure metric, and wherein selecting the landing zone location includes selecting the landing zone location in accordance with the energy expenditure metric.

In a fifth aspect, alone or in combination with one or more of the first through fourth aspects, deploying the unmanned vehicle to the landing zone location includes outputting a landing zone indication to the unmanned vehicle, and releasing the unmanned vehicle from a cargo area.

In a sixth aspect, alone or in combination with one or more of the first through fifth aspects, the unmanned vehicle is an unmanned aircraft system.

In a seventh aspect, alone or in combination with one or more of the first through sixth aspects, receiving the location beacon include receiving the location beacon via an infrared receiver.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

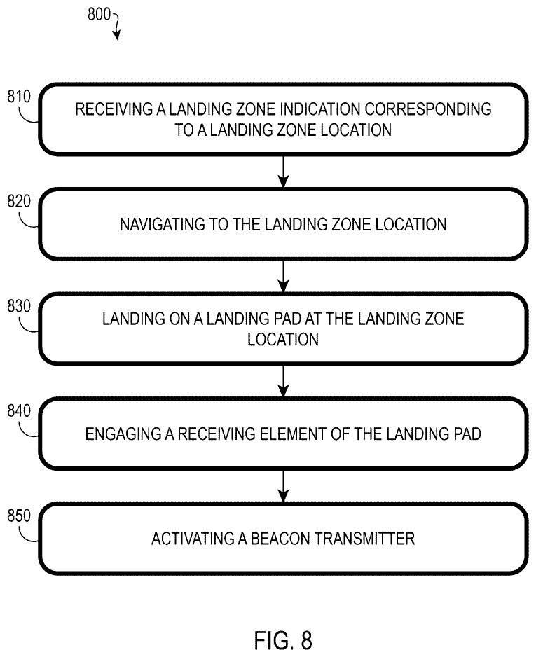

FIG. 8 is a flowchart of an example process 800 associated with autonomous landing support. One or more process blocks of FIG. 8 are performed by a vehicle (e.g., sUAS 110) and/or by another device or a group of devices separate from or including the vehicle. Additionally, or alternatively, one or more process blocks of FIG. 8 may be performed by one or more components of device 500, such as a beacon transmitter 125, memory 610, navigation system 615, actuators 620, processor 625, propulsion system 630, and/or communication system 635.

As shown in FIG. 8, process 800 includes receiving a landing zone indication corresponding to a landing zone location (block 810). For example, the vehicle may receive a landing zone indication corresponding to a landing zone location, as described above.

As further shown in FIG. 8, process 800 includes navigating to the landing zone location (block 820). For example, the vehicle may navigate to the landing zone location, as described above.

As further shown in FIG. 8, process 800 includes landing on a landing pad at the landing zone location (block 830). For example, the vehicle may land on a landing pad at the landing zone location, as described above.

As further shown in FIG. 8, process 800 includes engaging a receiving element of the landing pad (block 840). For example, the vehicle may engage a receiving element of the landing pad, as described above.

As further shown in FIG. 8, process 800 includes activating a beacon transmitter (block 850). For example, the vehicle may activate a beacon transmitter, as described above.

Process 800 may include additional aspects, such as any single aspect or any combination of aspects described below and/or in connection with one or more other processes described elsewhere herein.

In a first aspect, receiving the landing zone indication includes receiving the landing zone indication from a VTOL vehicle, such as an eVTOL vehicle (e.g., eVTOL vehicle 105).

In a second aspect, alone or in combination with the first aspect, navigating to the landing zone location includes exiting a cargo area of the VTOL vehicle.

In a third aspect, alone or in combination with one or more of the first and second aspects, engaging the receiver element of the landing pad includes activating a docking mechanism.

In a fourth aspect, alone or in combination with one or more of the first through third aspects, activating the docking mechanism includes outputting a control signal to an actuator.

In a fifth aspect, alone or in combination with one or more of the first through fourth aspects, engaging the receiving element of the landing pad includes aligning one or more magnets with the receiving element.

In a sixth aspect, alone or in combination with one or more of the first through fifth aspects, activating the beacon transmitter includes activating an infrared transmitter.

In a seventh aspect, alone or in combination with one or more of the first through sixth aspects, navigating to the landing zone location includes navigating to the landing zone location via a satellite positioning operation.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations described herein to the precise forms that are described. Modifications and variations may be made in light of the above description or may be acquired from practice of the implementations described herein.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations described herein. Thus, the operation and behavior of the systems and/or methods are described herein without reference to specific software code-it being understood that software and hardware can be designed to implement the systems and/or methods based on the description herein.

Even though particular combinations of features are recited in the claims and/or described in the specification, these combinations are not intended to limit the implementations described herein. In fact, many of these features may be combined in ways not specifically recited in the claims and/or described in the specification. Although each dependent claim listed below may directly depend on only one claim, the description includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a component” or “one or more components” (or another element, such as “a processor” or “one or more processors”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items,), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A first vehicle, comprising:
a cargo area storing a second vehicle;
a beacon receiver for receiving location beacon information transmitted from the second vehicle;
one or more memories; and
one or more processors, coupled to the one or more memories, configured to:
select a landing zone location from among one or more candidate landing zones while the first vehicle is moving to a destination,
wherein the landing zone location is selected based on at least an energy expenditure metric;
deploy the second vehicle to the landing zone location while the first vehicle is moving to the destination,
wherein the second vehicle is configured to be anchored to the landing zone via a receiving element of the landing zone;
navigate the first vehicle to the landing zone location by following the location beacon information received from the second vehicle that is anchored to the landing zone; and
perform a landing operation of the first vehicle at the landing zone location.

2. The first vehicle of claim 1, wherein the one or more processors, to select the landing zone location, are configured to query a database identifying the one or more candidate landing zones, and
wherein the database is stored in the one or more memories.

3. The first vehicle of claim 2, further comprising:
an avionics system configured to output a present location of the first vehicle; and
wherein the database associates each of the one or more candidate landing zones to a geographic location, and
wherein the one or more processors, to select the landing zone location, are configured to select the landing zone location in accordance with a proximity of each of the one or more candidate landing zones to a present location of the first vehicle.

4. The first vehicle of claim 2, wherein the database associates each of the one or more candidate landing zones to one or more landing characteristics, and
wherein the one or more processors, to select the landing zone location, are configured to select the landing zone location in accordance with the one or more landing characteristics of the one or more candidate landing zones.

5. (canceled)

6. The first vehicle of claim 1, wherein the one or more processors, to deploy the second vehicle to the landing zone location, are configured to:
output a landing zone indication to the second vehicle; and
release the second vehicle from the cargo area.

7. The first vehicle of claim 1, wherein the beacon receiver is an infrared receiver.

8. A method, comprising:
selecting, by a first vehicle and while the first vehicle is moving to a destination, a landing zone location from among one or more candidate landing zones;
deploying, by the first vehicle and from a cargo area of the first vehicle and while the first vehicle is moving to the destination, a second vehicle to the landing zone location,
wherein the second vehicle is configured to be anchored to the landing zone location via a receiving element of the landing zone location;
receiving, by a beacon receiver of the first vehicle and from the second vehicle that is anchored to the landing zone location, location beacon information;
navigating the first vehicle to the landing zone location by following the location beacon information; and
performing a landing operation of the first vehicle at the landing zone location.

9. The method of claim 8, wherein selecting the landing zone location includes querying a database identifying the one or more candidate landing zones.

10. The method of claim 9, wherein the database associates each of the one or more candidate landing zones to a geographic location, and
wherein selecting the landing zone location includes selecting the landing zone location in accordance with a proximity of each of the one or more candidate landing zones to a present vehicle location of the first vehicle.

11. The method of claim 9, wherein the database associates each of the one or more candidate landing zones to one or more landing characteristics, and
wherein selecting the landing zone location includes selecting the landing zone location in accordance with the one or more landing characteristics of the one or more candidate landing zones.

12. The method of claim 11, wherein at least one of the one or more landing characteristics for each of the one or more candidate landing zones includes an energy expenditure metric, and
wherein selecting the landing zone location includes selecting the landing zone location in accordance with the energy expenditure metric.

13. The method of claim 8, wherein deploying the second vehicle to the landing zone location includes:
outputting a landing zone indication to the second vehicle; and
releasing the vehicle from a cargo area.

14. The method of claim 8, wherein receiving the location beacon information includes receiving the location beacon information via an infrared receiver.

15. A first vehicle, comprising:
a propulsion system;
a docking mechanism;
a beacon transmitter configured to transmit location beacon information;
one or more memories; and
one or more processors, coupled to the one or more memories, configured to:
receive a landing zone indication corresponding to a landing zone location,
wherein the landing zone location is selected, from among one or more candidate landing zones, while a second vehicle, that stores the first vehicle, is moving to a destination;
control the propulsion system to navigate to the landing zone location and to land on a landing pad at the landing zone location;
activate the docking mechanism to engage a receiving element of the landing pad; and
activate the beacon transmitter to transmit the location beacon information with the first vehicle engaged to the receiving element.
wherein the location beacon information is configured to guide the second vehicle to an area associated with the landing pad.

16. The first vehicle of claim 15, wherein the one or more processors are further configured to receive the landing zone indication from a vertical takeoff and landing (VTOL) vehicle.

17. The first vehicle of claim 16, wherein the one or more processors, to control the propulsion system to navigate to the landing zone location, are configured to control the propulsion system to exit a cargo area of the VTOL vehicle.

18. The first vehicle of claim 15, wherein the one or more processors, to activate the docking mechanism to engage the receiver element of the landing pad, are configured to output one or more control signals to an actuator of the docking mechanism.

19. The first vehicle of claim 15, wherein the docking mechanism includes one or more magnets, and
wherein the one or more processors, to activate the docking mechanism to engage the receiving element of the landing pad, are configured to control the propulsion system to align the one or more magnets of the docking mechanism with the receiving element of the landing pad.

20. The first vehicle of claim 15, wherein the beacon transmitter is an infrared transmitter.

21. The first vehicle of claim 1, wherein the location beacon information is received from the second vehicle at least one of, during deployment of the second vehicle to the landing zone location or after the second vehicle being anchored.
